(19) United States
(12) Patent Application Publication
(10) Pub. No.: US 2013/0342326 A1
(43) Pub. Date: Dec. 26, 2013

(54) SYSTEMS, APPARATUSES, AND METHODS FOR TRANSPARENT AND UBIQUITOUS SENSING TECHNOLOGY

(71) Applicant: National Institute of Aerospace, Hampton, VA (US)

(72) Inventors: Chuantong Wang, Yorktown, VA (US); Stanley E. Woodard, Hampton, VA (US)

(73) Assignee: United States of America as represented by the Administrator of the National Aeronautics and Spac, Washington, DC (US)

(21) Appl. No.: 13/923,312

(22) Filed: Jun. 20, 2013

Related U.S. Application Data
(60) Provisional application No. 61/662,982, filed on Jun. 22, 2012.
(60) Provisional application No. 61/663,061, filed on Jun. 22, 2012.

(51) Int. Cl. H04B 5/00

(52) U.S. Cl. CPC H04B 5/0075
USPC 340/10.1

(57) ABSTRACT

One feature pertains to a sensor apparatus that comprises a conductor configured to perform at least one operation unrelated to the sensor apparatus. These operations may include at least one of providing structural support to a system unrelated to the sensor apparatus, and/or providing a non-sensing signal to the system unrelated to the sensor apparatus. The sensor apparatus also comprises at least one sensor configured to perform a sensing operation for the sensor apparatus that generates sensor data, and an interrogation circuit configured to interrogate the sensor by transmitting an interrogation signal to the sensor via the conductor. The sensor apparatus further comprises a processing circuit that receives from the sensor via the conductor a sensor response signal that includes the sensor data, where the sensor response signal is received in response to interrogating the sensor.

### CROSS-REFERENCE TO RELATED APPLICATIONS

The present application for patent claims priority to provisional application No. 61/662,982 entitled “Transparent and Ubiquitous Sensing Technology” filed Jun. 22, 2012, and provisional application No. 61/663,061 entitled “Using Ubiquitous Conductor to Power and Interrogate Wireless Passive Sensors and Construct Sensor Network” filed Jun. 22, 2012, the entire disclosures of which are hereby expressly incorporated by reference.

### STATEMENT REGARDING FEDERALLY SPONSORED RESEARCH

This invention was made with Government support under contract NCC1-02043 awarded by NASA. The Government has certain rights in the invention.

### BACKGROUND

1. Field

Various features pertain to sensor systems, sensors, and methods for sensing, and in particular to sensor systems, sensors, and methods for sensing that utilize an existing conductive architecture of a target system to facilitate transmission of sensor interrogation signals and reception of corresponding sensor response signals that include sensor retrieved data.

2. Description of Related Art

Traditionally, sensor networks/systems are independent systems that are separately designed, manufactured, and integrated into a target system, such as an aircraft, that needs the sensing capability. In most cases, this is a complex and costly process that requires sensor design, installation, wiring, testing, and maintenance. The sensor size, installation method, wiring, and cost may limit the sensor nodes to a limited number and/or locations within the target system. Moreover, because of these principle limitations there may be places within the target system where a traditional sensor system may not be able to access and provide sensed data.

For example, wireless sensor networks of the prior art that include active and/or passive sensors have distinct limitations. First, wireless sensor systems that include active sensor nodes using electromagnetic (EM) radio waves for communication have active sensors that typically each include many relatively expensive and complex components, such as a transmitter, a receiver, a processing circuit, and a power source (e.g., battery) in a single sensor node. Constructing a sensor network utilizing such complex sensors may prove prohibitively expensive, which may limit the number of sensors used. Second, a wireless sensor system's range may be limited due to a practical limit on the distance between the sensor and the interrogation circuit that interrogates the sensor since interrogation distance (i.e., range of interrogation signal) is limited by the power attenuation of the interrogation signal in space. For example, a wireless near field communication (NFC) sensor system that utilizes radio frequency identifier (RFID) sensors is typically limited such that the distance between the RFID sensor and the interrogation circuit needs to be less than 20 cm. As another example, an EM radio wave based sensor system (i.e., interrogation circuit and sensor(s) communicate with each other using EM radio waves) may have limited range due to a sensor's maximum transmission output power. Third, an EM radio wave based sensor system increases the electromagnetic interference (EMI) hazards to the sensing environments, including the target system that desires the sensing capability. These limitations and the tradeoffs between sensor range, sensor size, sensor robustness, sensor cost, and EMI concerns to the target system may prevent sensor networks from being used in certain applications.

Thus, there exists a need for sensor systems, sensor apparatuses, and methods for sensing that, among other things, improve sensor range, lower sensor network implementation and/or maintenance costs, reduce EMI, and increase sensor positioning options.

### SUMMARY

One feature provides a sensor apparatus that comprises a conductor configured to perform at least one operation unrelated to the sensor apparatus including at least one of (a) providing structural support to a system unrelated to the sensor apparatus, and/or (b) providing a non-sensing signal to the system unrelated to the sensor apparatus, at least one sensor communicatively coupled to the conductor, the sensor configured to perform a sensing operation for the sensor apparatus that generates sensor data, an interrogation circuit coupled to the conductor and configured to interrogate the sensor by transmitting an interrogation signal to the sensor via the conductor, and a processing circuit communicatively coupled to the conductor and configured to receive from the sensor via the conductor a sensor response signal that includes the sensor data, where the sensor response signal is received in response to interrogating the sensor. According to one aspect, the conductor simultaneously performs (a) the operation unrelated to the sensor apparatus and (b) at least one of transmitting the interrogation signal to the sensor and/or receiving the sensor response signal from the sensor. According to another aspect, the sensor includes an inductor-capacitor (LC) resonator having a resonance frequency that is wirelessly coupled to the conductor through magnetic induction. According to yet another aspect, the interrogation circuit transmits the interrogation signal to the sensor at substantially the resonance frequency.

According to one aspect, the sensor is an open circuit sensor. According to another aspect, the conductor is a monopole antenna. According to yet another aspect, the sensor is removeably coupled to the conductor.

According to one aspect, the apparatus further comprises a plurality of sensors communicatively coupled to the conductor, each of the plurality of sensors configured to perform a sensing operation for the sensor apparatus that generates sensor data unique to each sensor. According to another aspect, each of the plurality of sensors includes an inductor-capacitor (LC) resonator having a unique resonance frequency that is wirelessly coupled to the conductor through magnetic induction, and the interrogation circuit is further configured to uniquely interrogate each of the plurality of sensors by transmitting a unique interrogation signal to each of the plurality of sensors via the conductor at substantially the unique resonance frequency associated with the sensor being interrogated. According to yet another aspect, the conductor is a single monopole antenna that transmits the unique interrogation signal to each of the plurality of sensors.

According to one aspect, the system unrelated to the sensor apparatus is an aircraft and the conductor is a frame of the aircraft. According to another aspect, the system is a building and the conductor is wiring within the building.

Another feature provides a method operational at a sensor apparatus that comprises performing at a conductor at least one operation unrelated to the sensor apparatus including at least one of (a) providing structural support to a system unrelated to the sensor apparatus, and/or (b) providing a non-sensing signal to the system unrelated to the sensor apparatus, performing a sensing operation using at least one sensor for the sensor apparatus that generates sensor data, interrogating the sensor using an interrogation circuit by transmitting an interrogation signal to the sensor via the conductor, and receiving from the sensor via the conductor a sensor response signal that includes the sensor data, where the sensor response signal is received in response to interrogating the sensor. According to one aspect, the method further comprises performing a plurality of sensing operations for the sensor apparatus using a plurality of sensors, wherein each of the plurality of sensors generates sensor data unique to each sensor. According to another aspect, each of the plurality of sensors includes an inductor-capacitor (LC) resonator having a unique resonance frequency that is wirelessly coupled to the conductor through magnetic induction, and the method further comprises interrogating each of the plurality of sensors using the interrogation circuit by transmitting a unique interrogation signal to each of the plurality of sensors via the conductor at substantially the unique resonance frequency associated with the sensor being interrogated. According to yet another aspect, the conductor is a single monopole antenna that transmits the unique interrogation signal to each of the plurality of sensors.

Another feature provides a sensor apparatus that comprises at least one sensor configured to perform a sensing operation that generates sensor data, a monopole antenna wirelessly coupled to the sensor, an interrogation circuit coupled to the monopole antenna and configured to interrogate the sensor by transmitting an interrogation signal to the sensor via the monopole antenna, and a processing circuit communicatively coupled to the monopole antenna and configured to receive from the sensor via the conductor a sensor response signal that includes the sensor data, where the sensor response signal is received in response to interrogating the sensor. According to one aspect, the sensor includes an inductor-capacitor (LC) resonator having a resonance frequency that is wirelessly coupled to the monopole antenna through magnetic induction. According to another aspect, the interrogation circuit transmits the interrogation signal to the sensor at substantially the resonance frequency.

According to one aspect, the sensor apparatus further comprises a plurality of sensors communicatively coupled to the monopole antenna, each of the plurality of sensors configured to perform a sensing operation that generates sensor data unique to each sensor. According to another aspect, each of the plurality of sensors includes an inductor-capacitor (LC) resonator having a unique resonance frequency that is wirelessly coupled to the monopole antenna through magnetic induction, and the interrogation circuit is further configured to uniquely interrogate each of the plurality of sensors by transmitting a unique interrogation signal to each of the plurality of sensors via the monopole antenna at substantially the unique resonance frequency associated with the sensor being interrogated.

Another feature provides a method operational at a sensor apparatus that comprises performing, using a sensor, a sensing operation that generates sensor data, interrogating the sensor by transmitting an interrogation signal to the sensor via a monopole antenna wirelessly coupled to the sensor, and receiving from the sensor via the conductor a sensor response signal that includes the sensor data, where the sensor response signal is received in response to interrogating the sensor. According to one aspect, the method further comprises performing a plurality of sensing operations for the sensor apparatus using a plurality of sensors wirelessly coupled to the monopole antenna, wherein each of the plurality of sensors generates sensor data unique to each sensor. According to another aspect, each of the plurality of sensors includes an inductor-capacitor (LC) resonator having a unique resonance frequency that is wirelessly coupled to the monopole antenna through magnetic induction, and the method further comprises interrogating each of the plurality of sensors by transmitting a unique interrogation signal to each of the plurality of sensors via the monopole antenna at substantially the unique resonance frequency associated with the sensor being interrogated.

### BRIEF DESCRIPTION OF THE DRAWINGS

FIG. 1 illustrates a schematic block diagram of a ubiquitous and transparent sensor system.

FIG. 2 illustrates a first exemplary implementation of a ubiquitous and transparent sensor system/apparatus.

FIG. 3 illustrates a second exemplary implementation of a ubiquitous and transparent sensor system/apparatus.

FIGS. 4, 5, and 6 illustrate common components/parts that may behave like an inductor-capacitor-resistor (LCR) or inductor-capacitor (LC) resonator when powered/energized by an oscillating magnetic field.

FIGS. 7, 8, 9, and 10 illustrate examples of common components/parts that have impedance resonance characteristics (e.g., current-voltage (I-V) resonance) and EM wave resonance.

FIG. 11 illustrates an LCR open-circuit sensor.

FIG. 12 illustrates a schematic diagram of an LCR closed-circuit sensor.

FIG. 13 illustrates a frame (e.g., airplane frame) having a plurality of holes.

FIG. 14 illustrates how a frame having a plurality of holes may be redesigned into a frame having a plurality of LCR resonators.

FIG. 15 illustrates a schematic block diagram of a ubiquitous and transparent sensor system.

FIG. 16 illustrates an exemplary switch used in a sensor system.

FIG. 17 illustrates an exemplary T-connector used in a sensor system.

FIG. 18 illustrates a timing and amplitude graph of an interrogation signal transmitted by an interrogation circuit and a sensor response signal received in response to the interrogation signal.

FIG. 19 illustrates a schematic block diagram of a ubiquitous and transparent sensor system.

FIG. 20 illustrates another schematic block diagram of a ubiquitous and transparent sensor system.

FIG. 21 illustrates a monopole antenna inductively coupled to a sensor.

FIG. 22 illustrates an amplifier circuit used to amplify an interrogation signal received from an interrogation circuit.

FIG. 23 illustrates a length of a monopole antenna oriented so that it is parallel to lengths of conductive strips of an open-circuit LCR sensor to maximize magnetic field density through the LCR sensor.

FIG. 24 illustrates an inductor of a closed-circuit LCR sensor oriented relative to a monopole antenna to maximize magnetic field density through the inductor.

FIG. 25 illustrates a monopole antenna inductively coupled to n plurality of LCR sensors.

FIG. 26 illustrates a first exemplary flow chart for a method operational at a sensor apparatus.

FIG. 27 illustrates a second exemplary flow chart for a method operational at a sensor apparatus.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. As used herein, the phrase “communicatively coupled” means that two components are in communication with each other through at least one of a wired connection (e.g., conductive wire or fiber optic cable) and/or wirelessly.

### Overview

Aspects of the disclosure pertain to sensor systems, sensor apparatuses, and methods of using the same where existing components/parts of a target system that desire sensing functionality are used not only for their ordinary purposes for the target system but also for sensing purposes and networking sensor nodes. Notably, the existing components/parts of the target system reused for sensing functionality are conductors of the target system. For example, a conductive wire and/or network of wires (e.g., power line, communication line, etc.) within a building may be additionally used as the conductive element to transmit and receive signals associated with the sensor apparatus.

In this sense, the sensor systems, apparatuses, and methods described herein may be considered “transparent” in that the sensors are composed of the same components/parts of those already in the target system. Thus, limited and/or no additional, independent sensor components and/or other significant changes to the target system may be required to implement the sensor apparatuses and methods on the target system.

The sensor systems, apparatuses, and methods described herein may also be considered “ubiquitous” in that the sensors may access places for sensing that are difficult and/or not possible for traditional sensing systems. The sensor apparatuses and methods described herein may allow the target system to be more thoroughly monitored with reduced sensor system complexity and cost. Its application may be implemented in a variety of settings including but not limited to sensing applications on aircraft, ships, buildings, vehicles, and other systems with minor hardware changes and little additional cost impact.

Exemplary Systems, Apparatuses, and Methods for Ubiquitous and Transparent Sensors

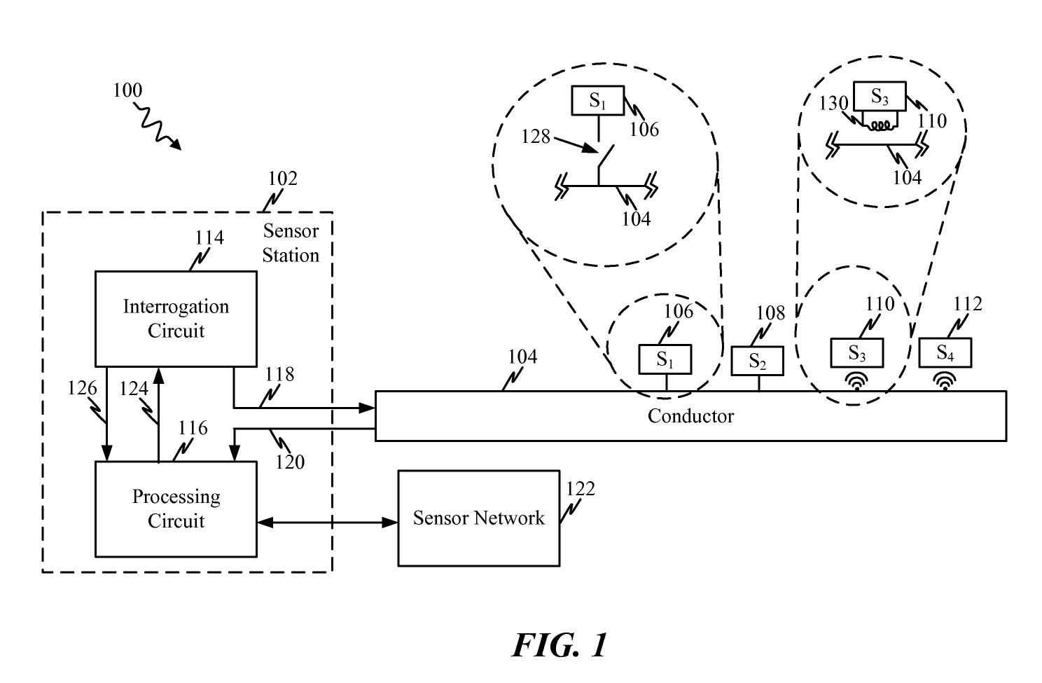

FIG. 1 illustrates a schematic block diagram of a ubiquitous and transparent sensor system 100 (e.g., also referred to herein as a “sensor apparatus”) according to one aspect of the disclosure. The sensor system 100 comprises a sensor station (SS) 102, a conductor 104, and at least one sensor 106, 108, 110, 112.

The sensors 106, 108, 110, 112 perform sensing operations that may include but are not limited to sensing, recording, and/or processing the following types of information: temperature, pressure, humidity, electromagnetic signal intensity (e.g., visible light intensity), ionizing radiation levels, system damage (e.g., damage to the sensor itself manifested by a change in the sensor's resonant frequency), etc. The sensors 106, 108, 110, 112 may include communication interfaces that communicatively couple the sensors 106, 108, 110, 112 to the conductor 104 through, for example, wired and/or wireless communication mediums. As described in greater detail below the sensors 106, 108, 110, 112 may include inductor-capacitor-resistor (LCR) resonance circuits and thus be LC or LCR resonant sensors. The sensors 106, 108, 110, 112 may be, for example, open-circuit LCR resonant sensors or closed-circuit LCR resonant sensors. In the example shown, the sensor system 100 comprises a plurality of sensors 106, 108, 110, 112 where a first pair of sensors 106, 108 are wired sensors (i.e., coupled to the conductor 104 via a conductive wire through a switch 128) and a second pair of sensors 110, 112 are wireless sensors (e.g., wirelessly coupled to the conductor 104 through near field communication such as magnetic induction 130). In practice the sensor system 100 may include any number of sensors equal to or greater than one (1) that are all or in part wired sensors or wireless sensors.

The conductor 104 is a conductive element that is configured to provide (e.g., transmit and/or receive) one or more signals (e.g., interrogation signal, sensor response signal, power signal, etc.) between the sensor station 102 and the sensors 106, 108, 110, 112. Notably, the conductor 104 may be an existing conductive element in the target system to which the sensor system 100 is providing sensing capabilities to. For example, the conductor 104 may be the metal frame of an aircraft, maritime vessel, motor vehicle, or any general device having a metal frame. According to other examples, the conductor 104 may be a conductive wire and/or conductive wire network (e.g., power lines, communication lines, metal water pipes, etc.) within a building, aircraft, maritime vessel, motor vehicle, or any general device having a conductive wire network. (These are simply non-limiting examples of target systems that include conductors that may serve as the conductor 104 for the sensor system 100.) Thus, the conductor 104 is configured to perform at least one operation unrelated to the sensor system 100 including at least one of providing structural support to the target system unrelated to the sensor system 100, and/or providing a non-sensing signal to the target system unrelated to the sensor system 100. According to one aspect of the disclosure, the conductor 104 may be a monopole antenna. According to another aspect, the conductor 104 may be a dipole antenna or a loop antenna.

The sensor station 102 may comprise an interrogation circuit 114 and a processing circuit 116. The interrogation circuit 114 is communicatively coupled to the conductor 104. The interrogation circuit 114 generates and transmits an interrogation signal 118 to the sensors 106, 108, 110, 112 via the conductor 104 that interrogates the sensors 106, 108, 110, 112. Once received by the sensors 106, 108, 110, 112, the interrogation signal 118 causes the sensors 106, 108, 110, 112 to generate and transmit back one or more sensor response signals 120 that may include sensor data collected by the sensors 106, 108, 110, 112. According to one example, the sensors 106, 108, 110, 112 may be passive sensors and the interrogation signal 118 powers the passive sensors 106, 108, 110, 112. According to other examples, the sensors 106, 108, 110, 112 are active sensors 106, 108, 110, 112 that have their own power supply (e.g., battery).

The interrogation circuit 114 may generate a plurality of interrogation signals 118 where each interrogation signal 118 generated is associated with a unique sensor 106, 108, 110, 112. Each interrogation signal 118 may be, for example, tuned to a different frequency that substantially matches the unique resonant frequency of the associated sensor 106, 108, 110, 112 (assuming the sensor 106, 108, 110, 112 is an LCR or LC based resonant sensor). In response to the interrogation signals 118, each sensor 106, 108, 110, 112 may generate a unique sensor response signal 120 (e.g., at a unique resonant frequency associated with the sensor 106, 108, 110, 112 being interrogated) and transmit the sensor response signal 120 to the processing circuit 116 via the conductor 104.

According to one aspect, the processing circuit 116 receives the one or more sensor response signals 120 that may contain sensor data retrieved by the sensors 106, 108, 110, 112 and processes the sensor response signals and/or the sensor data received. For example, the processing circuit 116 may provide the sensor data to a sensor network 122 for sensor data processing. The processing circuit 116 may also be communicatively coupled to the interrogation circuit 114. For example, the processing circuit 116 may transmit control signals 124 to the interrogation circuit 114 that instruct the interrogation circuit 114 when and which sensors 106, 108, 110, 112 to interrogate. As another example, the interrogation circuit 114 may transmit trigger signals 126 to the processing circuit 116 that instruct the processing circuit 116 to begin sensor response signal and/or sensor data signal capture/acquisition (e.g., record/store sensor response signal and/or sensor data signals on the conductor line 104). The interrogation circuit 114 may transmit the trigger signals 126 after completing interrogation of the sensors 106, 108, 110, 112 since sensor response signals 118 are expected to be provided onto the conductor 104 from the sensors 106, 108, 110, 112 in response to the interrogation.

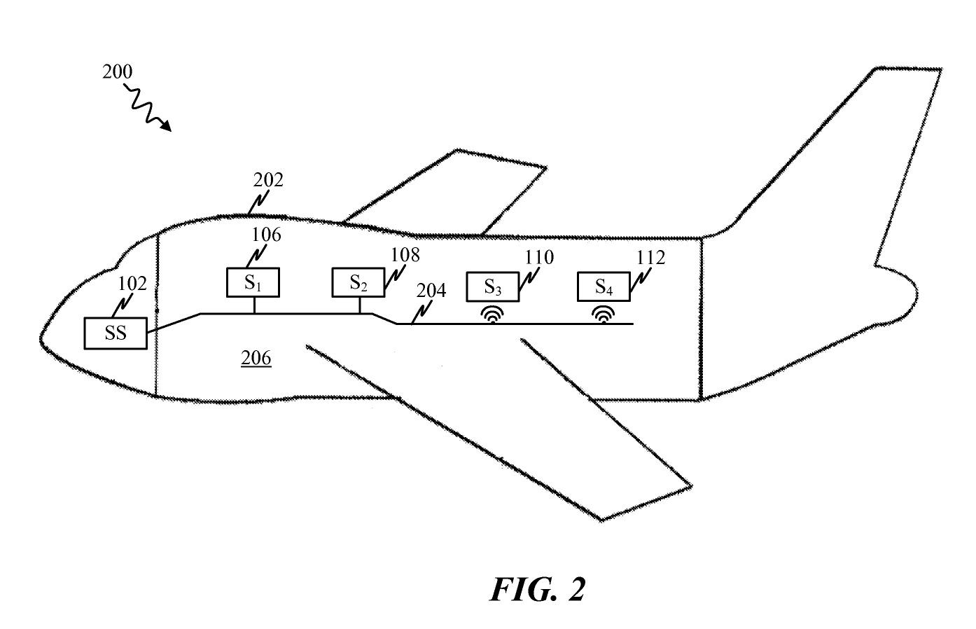

FIG. 2 illustrates an exemplary implementation of a ubiquitous and transparent sensor system/apparatus 200 according to one aspect of the disclosure. In the example shown, the sensor system 200 is incorporated within an aircraft 202 (i.e., target system is an aircraft), such as a commercial or military airplane, and an environment available conductor 204 is used as the conductor 104 shown in FIG. 1. Referring to FIG. 2, the environment available conductor 204 is an existing conductor native to the aircraft 202. For example, the conductor 204 may be representative of the metal frame or a portion of the metal frame of the aircraft 202. According to another example, the conductor 204 may be representative of a conductive wire or conductive wire network (e.g., a power line, ground line, or communication line (e.g., phone)) of the aircraft 202.

The sensor station 102 transmits one or more interrogation signals to the plurality of sensors 106, 108, 110, 112 and receives one or more sensor response signals from the sensors 106, 108, 110, 112 in response to the interrogation signals via the environment available conductor 204. Thus, the sensor system 200 takes advantage of existing conductive components of the aircraft 202 to transmit and receive interrogation and sensor response signals. The conductor 204 may also be used to power/energize the sensors 106, 108, 110, 112.

According to one example, the environment available conductor 204 may be a conductive wire embedded within one or more of the walls of the aircraft cabin 206 and the wireless sensors 110, 112 may still be communicatively coupled to the conductor 204 through the wall (i.e., the sensors 110, 112 are inside the cabin 206 positioned a reasonable distance that still makes magnetic induction near field communication (NFC) possible). In such a case the wireless sensors 110, 112 may be removeably coupled to the conductor 204 and thus easily be repositioned/reaffixed at various locations within the aircraft cabin 206 that still allow for NFC with the conductor 204.

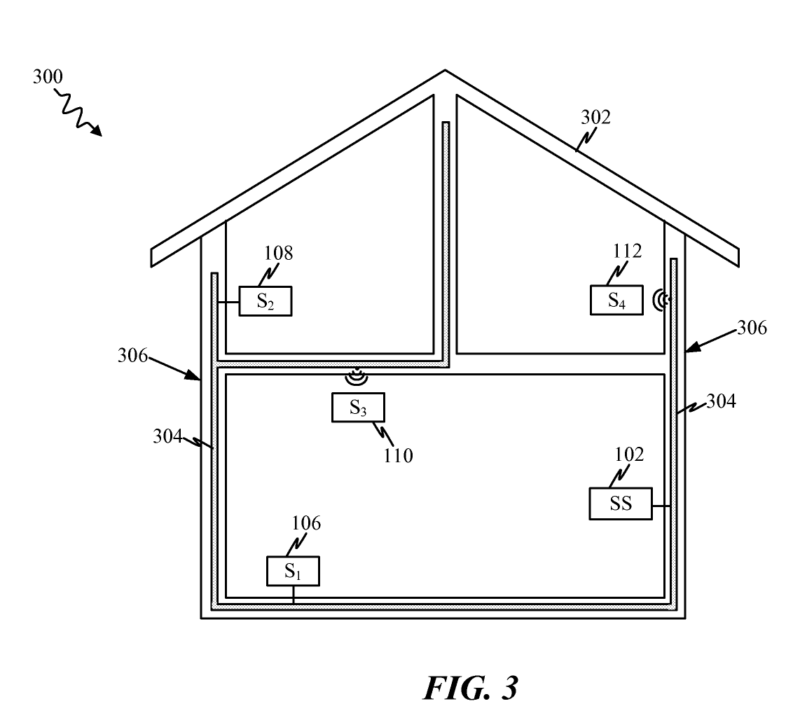

FIG. 3 illustrates another exemplary implementation of a ubiquitous and transparent sensor system/apparatus 300 according to one aspect of the disclosure. In the example shown, the sensor system 300 is incorporated within a building 302 (i.e., target system is a building), such as a home or office building, and an environment available conductor 304 is used as the conductor 104 shown in FIG. 1. Referring to FIG. 3, the environment available conductor 304 is an existing conductor native to the building 302. For example, the conductor 304 may be representative of a conductive wire or conductive wire network (e.g., a power line, ground line, or communication line (e.g., phone)) of the building 302.

The sensor station 102 transmits one or more interrogation signals to the plurality of sensors 106, 108, 110, 112 and receives one or more sensor response signals from the sensors 106, 108, 110, 112 in response to the interrogation signals via the environment available conductor 304. Thus, the sensor system 300 takes advantage of existing conductive components of the building 302 to transmit and receive interrogation and sensor response signals. The conductor 304 may also be used to power/energize the sensors 106, 108, 110, 112.

According to one example, the environment available conductor 304 may be a conductive wire embedded within one or more of the walls 306 of the building 302 and the wireless sensors 110, 112 may still be communicatively coupled to the conductor 304 through the wall (i.e., the sensors 110, 112 are inside one of the building's rooms positioned a reasonable distance that still makes magnetic induction near field communication (NFC) possible). In such a case the wireless sensors 110, 112 may be removeably coupled to the conductor 304 and thus easily be repositioned/reaffixed at various locations within the building 302 cabin that still allow for NFC with the conductor 304.

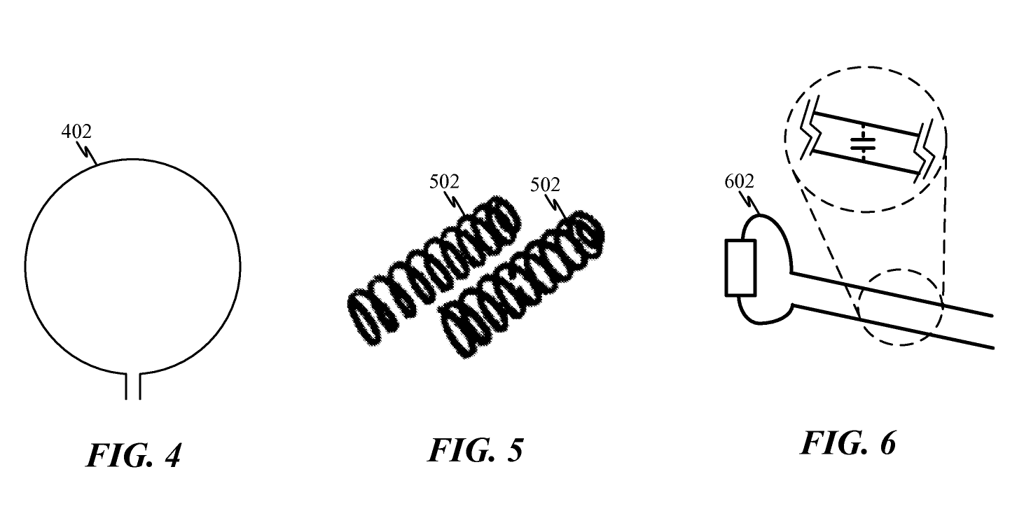

Physically, any conductive and/or dielectric component that can generate and/or maintain an electromagnetic (EM) field/wave oscillation may be used as an EM LCR or LC resonant sensor 106, 108, 110, 112. FIGS. 4-6 illustrate some components/parts that may behave like an LCR or LC resonator when powered/energized by an oscillating magnetic field. For example, FIG. 4 shows a conductive O-ring 402, FIG. 5 shows a spring 502, and FIG. 6 shows a dual line conductive wire 602. All these components 402, 502, 602 may behave like LCR or LC resonators. Thus, such components/parts 402, 502, 602 can be used as LCR or LC resonant sensors 106, 108, 110, 112 to perform sensing operations (e.g., sense temperature, pressure, humidity, electromagnetic signal intensity (e.g., visible light intensity), ionizing radiation levels, system damage, etc.) without affecting their non-sensing, original operations (e.g., transmit power to another part of the target system) that are unrelated to the sensor system/apparatus.

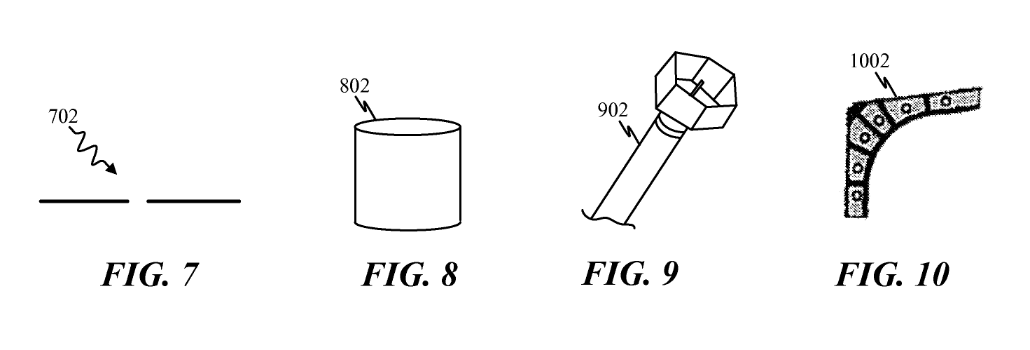

FIGS. 7, 8, 9, and 10 illustrate examples of components/parts that have impedance resonance characteristics (e.g., current-voltage (I-V) resonance) and EM wave resonance. For example, FIG. 7 shows a dipole antenna 702, FIG. 8 shows a dielectric component 802, FIG. 9 shows a coaxial cable 902, and FIG. 10 shows a conductive frame/structure 1002. All these components 702, 802, 902, 1002 may be used for sensing purposes.

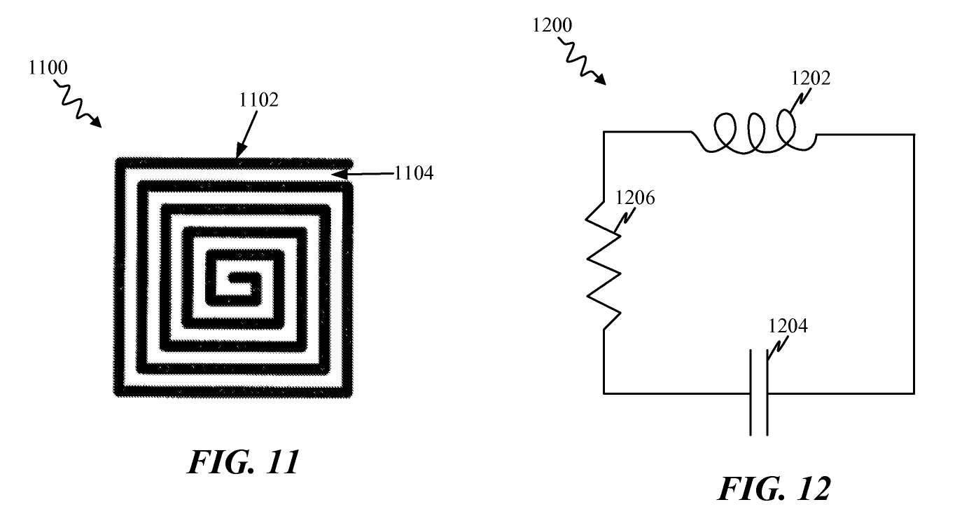

FIG. 11 illustrates an LCR open-circuit sensor 1100 according to one aspect of the disclosure. The LCR open-circuit sensor 1100 is comprised of a conductive strip 1102 formed into a planar, geometric loop where the rows of the conductive strip 1102 are separated by rows of dielectric material 1104. Capacitive coupling between alternating rows of the loop's conductive strip 1102 that sandwich rows of dielectric material 1104 contribute to the capacitance of the LCR open-circuit sensor 1100. The resistance of the conductive strip 1102 itself contributes the resistance of the LCR open-circuit sensor 1100. The windings of the conductive strip 1102 loop contribute to the inductance of the LCR open-circuit sensor 1100. The combined inductance, resistance, and capacitance of the LCR open-circuit sensor 1100 cause the sensor 1100 to have resonant frequencies that are unique to the LCR open-circuit sensor 1100. Varying any one of the inductance, capacitance, and/or resistance of the LCR open-circuit sensor 1100 will vary the resonant frequencies of the LCR open-circuit sensor 1100. Moreover, given the open-circuit nature of the LCR sensor 1100, the LCR sensor 1100 will still operate even if the LCR sensor 100 is physically damaged/altered. For example, if the conductive strip 1102 is cut due to physical trauma, the open-circuit sensor 1100 will still continue to function by generating and maintaining an oscillating EM wave, albeit at different resonant frequencies. According to one aspect, the sensor station 102 (e.g., processing circuit 116) may detect such a change in the resonant frequency of the sensor signal response signal 120 and assess that the LCR open-circuit sensor 1100 (and thus the target system itself) may have sustained damage.

FIG. 12 illustrates a schematic diagram of an LCR closed-circuit sensor 1200 according to one aspect of the disclosure. Like the LCR open-circuit sensor 1100 shown in FIG. 11, the LCR closed-circuit sensor 1200 of FIG. 12 includes an inductor 1202, a capacitor 1204, and a resistor 1206 that together define the resonant frequencies of the LCR closed-circuit sensor 1200. However, unlike the open-circuit sensor 1100, the closed-circuit sensor 1200 may not function properly if it is damaged. The sensors 106, 108, 110, 112 shown in FIGS. 1-3 may be any one of the sensors 1102, 1202 shown in FIGS. 11 and 12.

According to one aspect, existing components/parts of the target system may undergo minor revision/redesign so that they can serve as LCR or LC resonant sensors and still perform their intended original function for the target system. Such slight modification to the existing components/parts of the target system may be appropriate in some applications.

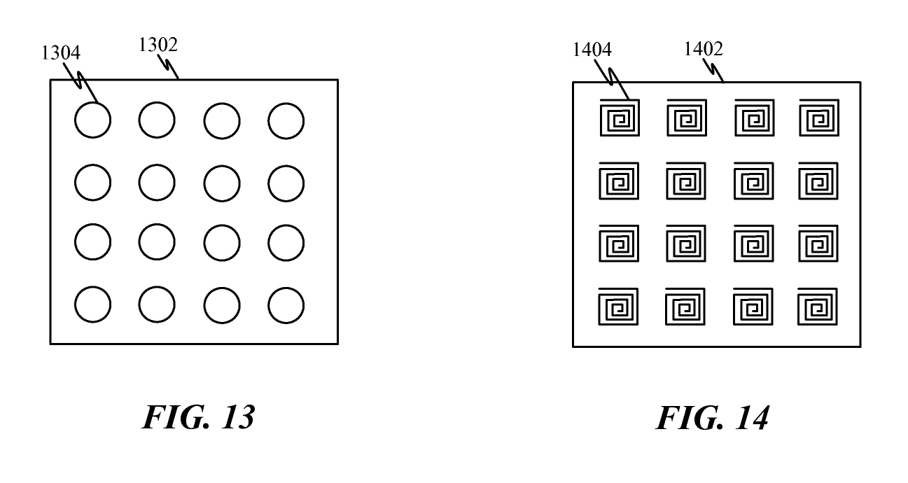

For example, FIG. 13 illustrates how a frame 1302 (e.g., airplane frame) having a plurality of holes 1304 may be redesigned into a frame 1402 as shown in FIG. 14 to have a plurality of LCR resonators 1404 according to one aspect of the disclosure. The LCR resonators 1404 are similar to the LCR resonators shown in FIG. 11.

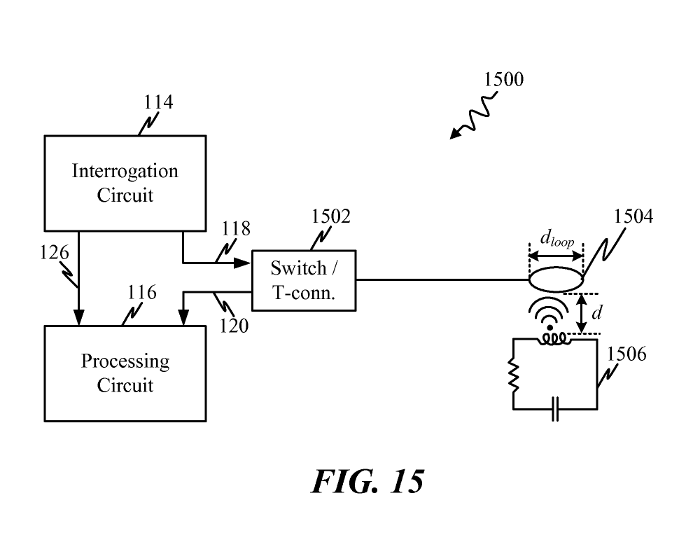

FIG. 15 illustrates a schematic block diagram of a ubiquitous and transparent sensor system 1500 according to one aspect of the disclosure. The sensor system 1500 comprises the interrogation circuit 114, the processing circuit 116, a switch/T-connector 1502, a conductive loop antenna 1504, and at least one passive LCR sensor 1506.

The passive LCR sensor 1506 may be an LCR open-circuit sensor (e.g., sensor 1100 in FIG. 11) or an LCR closed-circuit sensor (e.g., sensor 1200 in FIG. 12) that is spaced a distance d away from the loop antenna 1504. (Note that merely for illustrative simplicity the sensor 1506 of FIG. 15 is shown as the LCR closed-circuit sensor 1200 of FIG. 12 but may instead be the LCR open-circuit sensor 100 of FIG. 11.) The loop antenna 1504 interrogates the sensor 1506 with the interrogation signal 118 (may also be referred to herein as a “driving signal”) provided to it by the interrogation circuit 114. The loop antenna 1504 also receives the sensor response signal 120 from the sensor 1506 in response to the interrogation signal 118, and provides the sensor response signal 120 to the processing circuit 116. The interrogation circuit 114 may transmit a trigger signal 126 to the processing circuit 116 that instructs the processing circuit 116 to begin sensor response signal and/or sensor data signal capture/acquisition (e.g., record/store sensor response signal and/or sensor data signals from the loop antenna 1504). The interrogation circuit 114 may transmit the trigger signal 126 after completing interrogation of the sensors 1506 since the sensor response signal 118 is expected to be provided from the loop antenna 1504 in response to sensor 1506 interrogation. The distance d and/or the loop diameter dₗₒₒₚ determines at least in part the power of the interrogation signal 118 required to properly power the passive LCR sensor 1506.

The switch/T-connector 1502 may be, for example, either a switch or a T-connector (e.g., circulator) that allows the interrogation signal 118 to be sent from the interrogation circuit 114 to the sensor 1506 without inadvertently transmitting the interrogation signal 118 to the processing circuit 116. Similarly, the switch or T-connector allows the sensor response signal 120 to be transmitted from the sensor 1506 to the processing circuit 116 without inadvertently transmitting the sensor response signal 120 to the interrogation circuit 114.

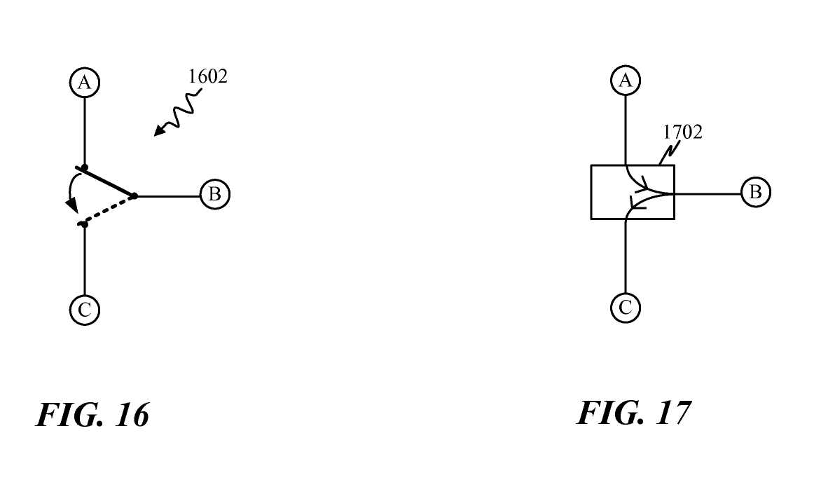

FIG. 16 illustrates an example of where the switch/T-connector 1502 of FIG. 15 is a switch 1602 according to one aspect. Referring to FIG. 16, the switch 1602 may close such that it creates a short circuit between node A (node coupled to the interrogation circuit 114) and node B (node coupled to the loop antenna 1504 or conductor 104 (See FIG. 1)) when the interrogation circuit 114 desires to transmit the interrogation signal 118 (referred to as “short circuit A-B position”). Alternatively, the switch 1602 may close such that it creates a short circuit between node B (node coupled to the loop antenna 1504 or conductor 104 (See FIG. 1)) and node C (node coupled to the processing circuit 116) when the processing circuit 116 expects to receive the sensor response signal 120 (referred to as “short circuit B-C position”). Note that once the interrogation signal 118 is finished being transmitted by the interrogation circuit 114 and the sensor response signal 120 is expected on the loop antenna 1504 or conductor 104 (e.g., loop antenna 1504), the switch 1602 may transition from the short circuit A-B position to the short circuit B-C position. In one example the trigger signal 126 may control the switch 1602 to cause the transition.

FIG. 17 illustrates an example of where the switch/T-connector 1502 of FIG. 15 is a T-connector 1702 (e.g., circulator) according to another aspect. Referring to FIG. 17, the T-connector 1702 allows signal transmissions (e.g., interrogation signal 118) to be transmitted from node A to node B and also allows signal transmissions (e.g., sensor response signal 120) from node B to node C. The T-connector 1702 may isolate nodes A and C from one another.

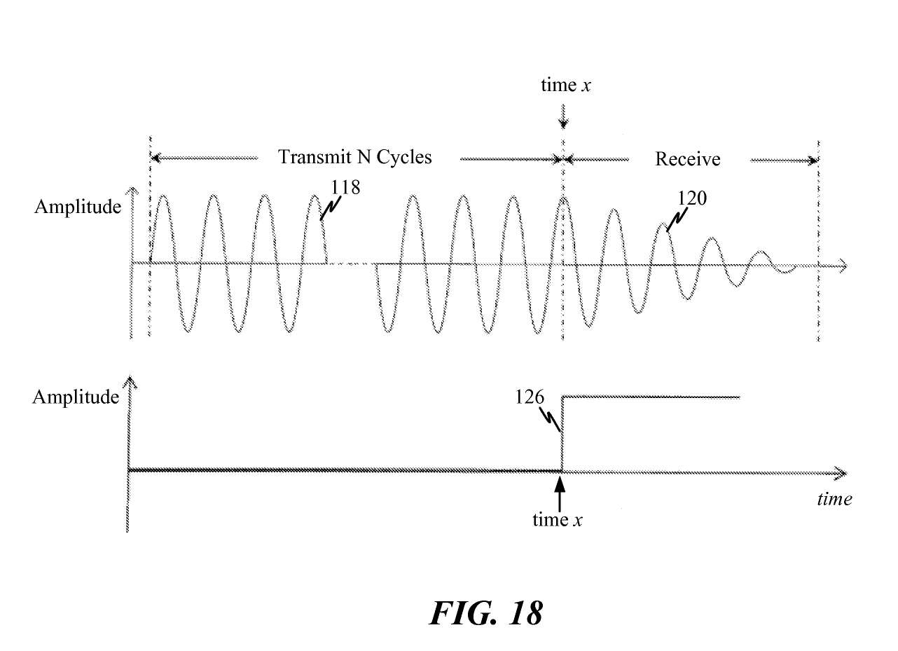

FIG. 18 illustrates a timing and amplitude graph of the interrogation signal 118 transmitted by the interrogation circuit 114 and the sensor response signal 120 received in response to the interrogation signal 118 according to one aspect. It may be observed that at time x the interrogation signal 118 ceases transmission (e.g., switch 1602 transitions from short circuit A-B position to short circuit B-C position) and the processing circuit 116 begins to receive the sensor response signal 120. Simultaneously, the trigger signal 126 is asserted and sent to the processing circuit 116 from the interrogation circuit 114 to cause the processing circuit 116 to begin data acquisition (storing/recording) the sensor response signal 120 that may contain the sensor data. The sensor response signal 120 may be characterized by a harmonically dampened signal.

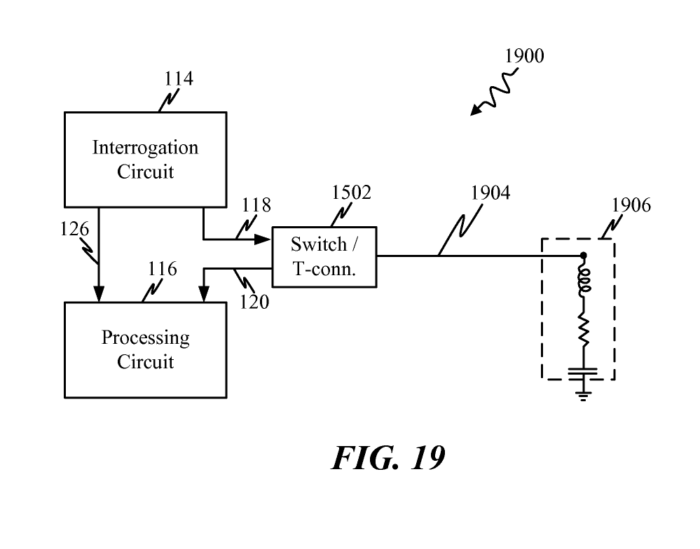

FIG. 19 illustrates a schematic block diagram of a ubiquitous and transparent sensor system 1900 according to one aspect of the disclosure. The sensor system 1900 comprises the interrogation circuit 114, the processing circuit 116, the switch/T-connector 1502, a conductive wire 1904, and at least one impedance resonant sensor 1906, such as the impedance resonators shown in FIGS. 7-10. Operation of the sensor system 1900 is very similar to that described above with respect to FIGS. 15-18.

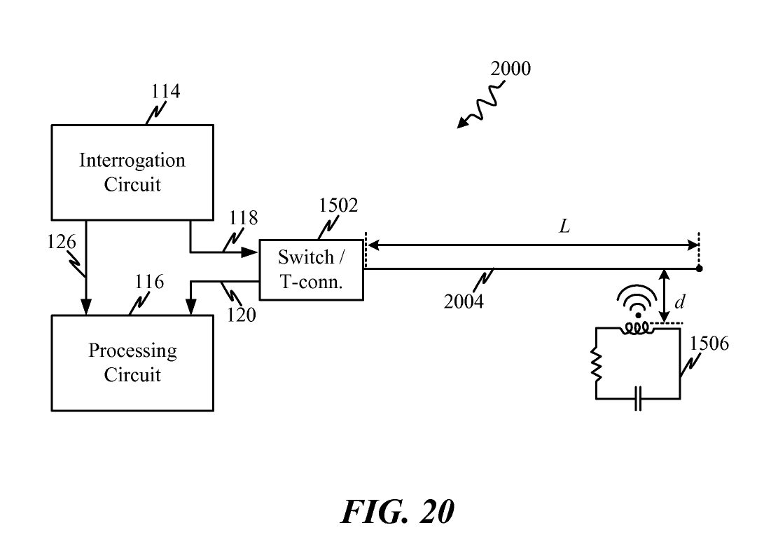

FIG. 20 illustrates a schematic block diagram of a ubiquitous and transparent sensor system 2000 according to one aspect of the disclosure. The sensor system 2000 comprises the interrogation circuit 114, the processing circuit 116, the switch/T-connector 1502, a monopole antenna 2004, and at least one LCR resonant sensor 1506, such as open-circuit sensor 1100 or closed-circuit sensor 1200. (Note that merely for illustrative simplicity the sensor 1506 of FIG. 20 is shown as the LCR closed-circuit sensor 1200 of FIG. 12 but may instead be the LCR open-circuit sensor 1100 of FIG. 11.) The monopole antenna 2004 acts as a conductor and is coupled to the sensor 1506 through magnetic induction. The monopole antenna 2004 interrogates the sensor 1506 and receives the sensor response signal similar to the process described above with respect to FIGS. 15-18.

For example, the interrogation circuit 114 generates and transmits the interrogation signal 118 to the sensor 1506 via the monopole antenna 2004, and in response, the processing circuit 116 receives the sensor response signal 120 via the monopole antenna 2004. The distance d between the sensor 1506 and monopole antenna 2004 and the length L of the monopole antenna 2004 are determined at least in part by the power (consequently the magnetic field density) of the interrogation signal 118.

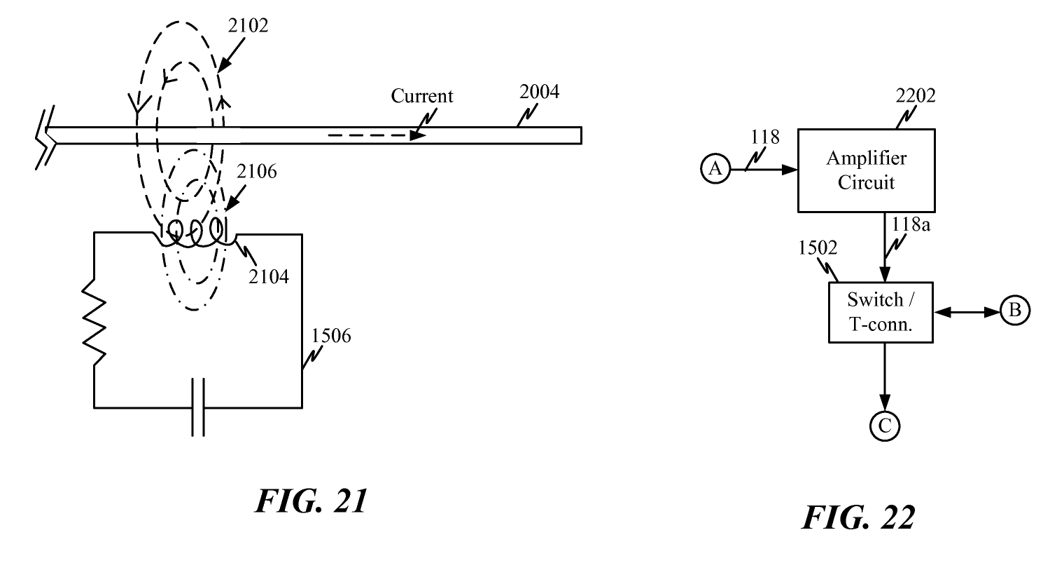

FIG. 21 illustrates the monopole antenna 2004 inductively coupled to the sensor 1506 according to one aspect. Specifically, the monopole antenna 2004 carries an alternating current (AC) (given by dashed arrow at some instance in time) that generates an electromagnetic field 2102 around the monopole antenna 2004 as shown. The EM field 2102 inductively couples with the inductor 2104 of the LCR sensor 1506 to transmit the interrogation signal 118. Similarly, the LCR sensor 1506 generates its own EM field (dot-dashed line) 2106 that inductively couples to the monopole antenna 2004 to transmit the sensor response signal 120. According to one example, the interrogation signal 118 produces the AC current having a frequency about equal to the resonant frequency of the sensor 1506. (Note that merely for illustrative simplicity the sensor 1506 of FIG. 21 is shown as the LCR closed-circuit sensor 1200 of FIG. 12 but may instead be the LCR open-circuit sensor 1100 of FIG. 11.)

FIG. 22 illustrates how an amplifier circuit 2202 can be used to amplify the interrogation signal 118 received from the interrogation circuit 114 (i.e., from node A) before providing the amplified signal 118a to the switch/T-connector 1502. In FIG. 22 node B represents the path to the monopole antenna 2004 and node C represents the path to the processing circuit 116 (see e.g. FIG. 1).

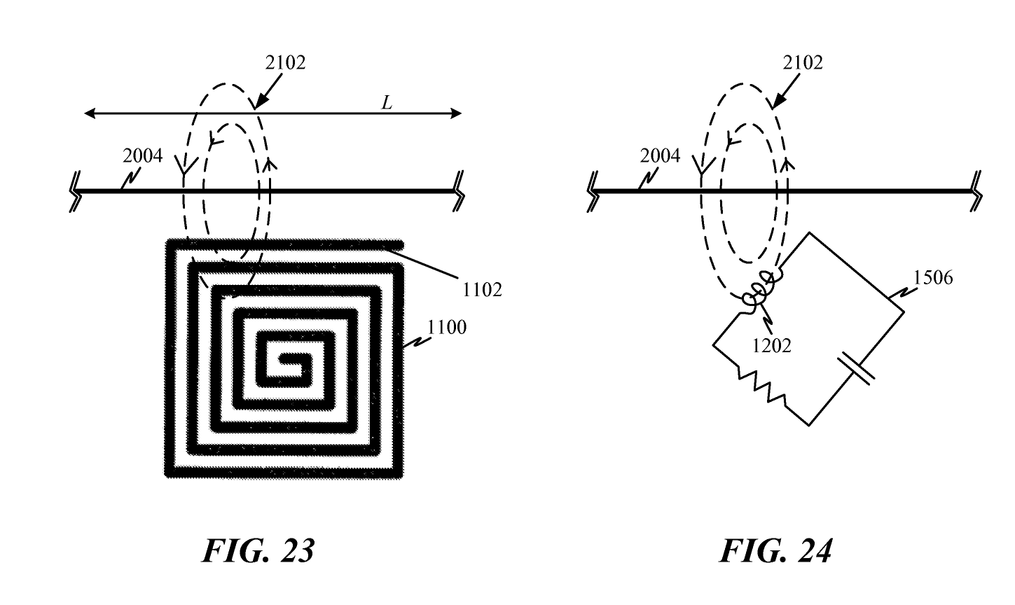

FIGS. 23 and 24 illustrate how to optimize inductive coupling between the monopole antenna 2004 and the LCR sensors 1100, 1200 according to one aspect. FIG. 23 shows how the length L of the monopole antenna 2004 may be oriented such that it is parallel to the length of the conductive strips 1102 of the open-circuit LCR sensor 1100 so that the maximum magnetic field density passes through the LCR sensor 1100. Similarly, FIG. 24 shows how the inductor 2402 of a closed-circuit LCR sensor 1200 is oriented relative to the monopole antenna 2004 to maximize magnetic field density through the inductor 1202.

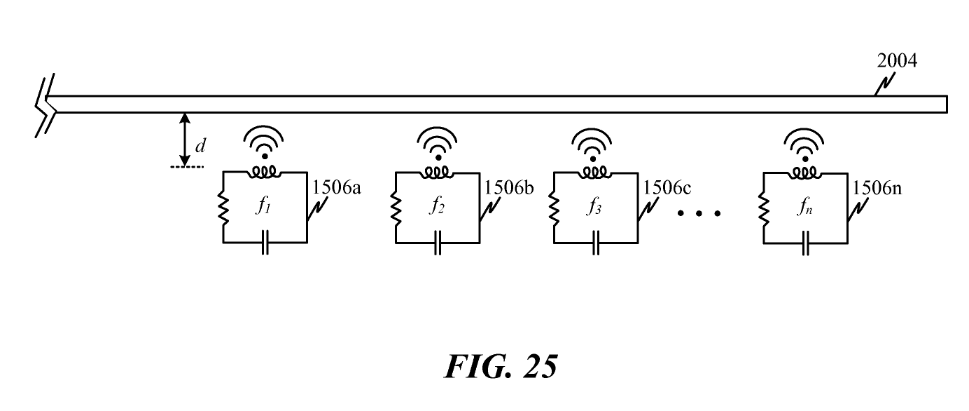

FIG. 25 illustrates the monopole antenna 2004 inductively coupled to n plurality of LCR sensors 1506a, 1506b, 1506c, 1506n according to one aspect where n is an integer greater than or equal to two (2). In the illustrated example, each LCR sensor 1506a, 1506b, 1506c, 1506n has a different resonant frequency f₁, f₂, f₃, . . . fₙ. The interrogation circuit 114 (see FIG. 20) may transmit an interrogation signal 118 at a specific resonant frequency f₁, f₂, f₃, . . . fₙ in order to interrogate a unique sensor 1506a, 1506b, 1506c, 1506n associated with the resonant frequency f₁, f₂, f₃, . . . fₙ. In this fashion a single monopole antenna can wirelessly communicate with a plurality of LCR sensors 1506a, 1506b, 1506c, 1506n. (Note that merely for illustrative simplicity the sensors 1506a, 1506b, 1506c, 1506n of FIG. 25 are shown as LCR closed-circuit sensors 1200 of FIG. 12 but may instead be LCR open-circuit sensors 1100 of FIG. 11.)

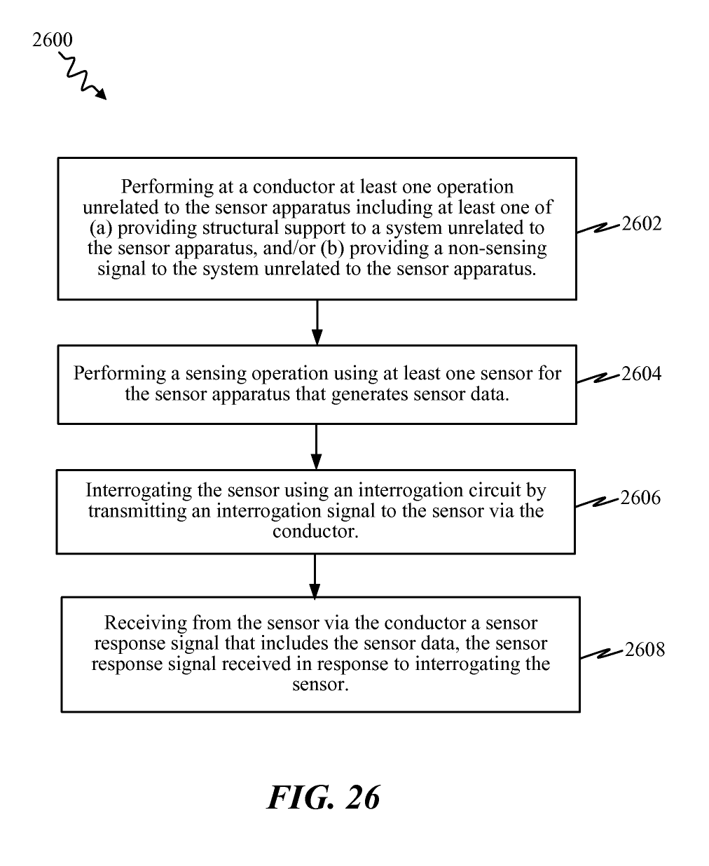

FIG. 26 illustrates a flow chart 2600 for a method operational at a sensor apparatus according to one aspect. First, at least one operation unrelated to the sensor apparatus is performed at a conductor including at least one of (a) providing structural support to a system unrelated to the sensor apparatus, and/or (b) providing a non-sensing signal to the system unrelated to the sensor apparatus 2602. Next, a sensing operation is performed using at least one sensor for the sensor apparatus that generates sensor data 2604. Then, the sensor is interrogated using an interrogation circuit by transmitting an interrogation signal to the sensor via the conductor 2606. Next, a sensor response signal that includes the sensor data is received from the sensor via the conductor, where the sensor response signal is received in response to interrogating the sensor 2608.

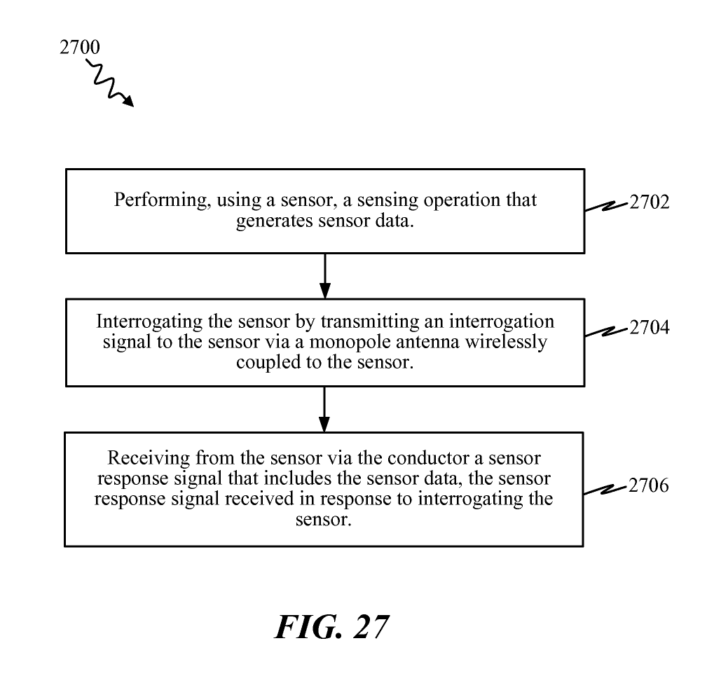

FIG. 27 illustrates a flow chart 2700 for method operational at a sensor apparatus according to another aspect. First, a sensing operation that generates sensor data is performed using a sensor 2702. Next, the sensor is interrogated by transmitting an interrogation signal to the sensor via a monopole antenna wirelessly coupled to the sensor 2704. Then, a sensor response signal that includes the sensor data is received from the sensor via the conductor, where the sensor response signal is received in response to interrogating the sensor 2706.

One or more of the components, steps, features, and/or functions illustrated in FIGS. 1, 2, 3, 4, 5, 6, 7, 8, 9, 10, 11, 12, 13, 14, 15, 16, 17, 18, 19, 20, 21, 22, 23, 24, 25, 26, and/or 27 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 2, 3, 4, 5, 6, 7, 8, 9, 10, 11, 12, 13, 14, 15, 16, 17, 19, 20, 21, 22, 23, 24, and/or 25 may be configured to perform one or more of the methods, features, or steps described in FIGS. 18, 26, and/or 27. The algorithms described herein may also be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A sensor apparatus, comprising:
a conductor configured to perform at least one operation unrelated to the sensor apparatus including at least one of (a) providing structural support to a system unrelated to the sensor apparatus, and/or (b) providing a non-sensing signal to the system unrelated to the sensor apparatus;
at least one sensor communicatively coupled to the conductor, the sensor configured to perform a sensing operation for the sensor apparatus that generates sensor data;
an interrogation circuit coupled to the conductor and configured to interrogate the sensor by transmitting an interrogation signal to the sensor via the conductor; and
a processing circuit communicatively coupled to the conductor and configured to receive from the sensor via the conductor a sensor response signal that includes the sensor data, the sensor response signal received in response to interrogating the sensor.

2. The sensor apparatus of claim 1, wherein the conductor simultaneously performs (a) the operation unrelated to the sensor apparatus and (b) at least one of transmitting the interrogation signal to the sensor and/or receiving the sensor response signal from the sensor.

3. The sensor apparatus of claim 1, wherein the sensor includes an inductor-capacitor (LC) resonator having a resonance frequency that is wirelessly coupled to the conductor through magnetic induction.

4. The sensor apparatus of claim 3, wherein the interrogation circuit transmits the interrogation signal to the sensor at substantially the resonance frequency.

5. The sensor apparatus of claim 4, wherein the sensor is an open circuit sensor.

6. The sensor apparatus of claim 4, wherein the conductor is a monopole antenna.

7. The sensor apparatus of claim 1, wherein the sensor is removeably coupled to the conductor.

8. The sensor apparatus of claim 1, further comprising:
a plurality of sensors communicatively coupled to the conductor, each of the plurality of sensors configured to perform a sensing operation for the sensor apparatus that generates sensor data unique to each sensor.

9. The sensor apparatus of claim 8, wherein each of the plurality of sensors includes an inductor-capacitor (LC) resonator having a unique resonance frequency that is wirelessly coupled to the conductor through magnetic induction, and the interrogation circuit is further configured to uniquely interrogate each of the plurality of sensors by transmitting a unique interrogation signal to each of the plurality of sensors via the conductor at substantially the unique resonance frequency associated with the sensor being interrogated.

10. The sensor apparatus of claim 9, wherein the conductor is a single monopole antenna that transmits the unique interrogation signal to each of the plurality of sensors.

11. The sensor apparatus of claim 1, wherein the system unrelated to the sensor apparatus is an aircraft and the conductor is a frame of the aircraft.

12. The sensor apparatus of claim 1, wherein the system is a building and the conductor is wiring within the building.

13. A method operational at a sensor apparatus, comprising:
performing at a conductor at least one operation unrelated to the sensor apparatus including at least one of (a) providing structural support to a system unrelated to the sensor apparatus, and/or (b) providing a non-sensing signal to the system unrelated to the sensor apparatus;
performing a sensing operation using at least one sensor for the sensor apparatus that generates sensor data;
interrogating the sensor using an interrogation circuit by transmitting an interrogation signal to the sensor via the conductor; and
receiving from the sensor via the conductor a sensor response signal that includes the sensor data, the sensor response signal received in response to interrogating the sensor.

14. The method of claim 13, further comprising:
performing a plurality of sensing operations for the sensor apparatus using a plurality of sensors, wherein each of the plurality of sensors generates sensor data unique to each sensor.

15. The method of claim 14, wherein each of the plurality of sensors includes an inductor-capacitor (LC) resonator having a unique resonance frequency that is wirelessly coupled to the conductor through magnetic induction, and the method further comprises:
interrogating each of the plurality of sensors using the interrogation circuit by transmitting a unique interrogation signal to each of the plurality of sensors via the conductor at substantially the unique resonance frequency associated with the sensor being interrogated.

16. The method of claim 15, wherein the conductor is a single monopole antenna that transmits the unique interrogation signal to each of the plurality of sensors.

17. A sensor apparatus, comprising:
at least one sensor configured to perform a sensing operation that generates sensor data;
a monopole antenna wirelessly coupled to the sensor;
an interrogation circuit coupled to the monopole antenna and configured to interrogate the sensor by transmitting an interrogation signal to the sensor via the monopole antenna; and
a processing circuit communicatively coupled to the monopole antenna and configured to receive from the sensor via the conductor a sensor response signal that includes the sensor data, the sensor response signal received in response to interrogating the sensor.

18. The sensor apparatus of claim 17, wherein the sensor includes an inductor-capacitor (LC) resonator having a resonance frequency that is wirelessly coupled to the monopole antenna through magnetic induction.

19. The sensor apparatus of claim 18, wherein the interrogation circuit transmits the interrogation signal to the sensor at substantially the resonance frequency.

20. The sensor apparatus of claim 19, wherein the sensor is an open circuit sensor.

21. The sensor apparatus of claim 17, further comprising:
a plurality of sensors communicatively coupled to the monopole antenna, each of the plurality of sensors configured to perform a sensing operation that generates sensor data unique to each sensor.

22. The sensor apparatus of claim 21, wherein each of the plurality of sensors includes an inductor-capacitor (LC) resonator having a unique resonance frequency that is wirelessly coupled to the monopole antenna through magnetic induction, and the interrogation circuit is further configured to uniquely interrogate each of the plurality of sensors by transmitting a unique interrogation signal to each of the plurality of sensors via the monopole antenna at substantially the unique resonance frequency associated with the sensor being interrogated.

23. A method operational at a sensor apparatus, comprising:
performing, using a sensor, a sensing operation that generates sensor data;
interrogating the sensor by transmitting an interrogation signal to the sensor via a monopole antenna wirelessly coupled to the sensor; and
receiving from the sensor via the conductor a sensor response signal that includes the sensor data, the sensor response signal received in response to interrogating the sensor.

24. The method of claim 23, further comprising:
performing a plurality of sensing operations for the sensor apparatus using a plurality of sensors wirelessly coupled to the monopole antenna, wherein each of the plurality of sensors generates sensor data unique to each sensor.

25. The method of claim 24, wherein each of the plurality of sensors includes an inductor-capacitor (LC) resonator having a unique resonance frequency that is wirelessly coupled to the monopole antenna through magnetic induction, and the method further comprises:
interrogating each of the plurality of sensors by transmitting a unique interrogation signal to each of the plurality of sensors via the monopole antenna at substantially the unique resonance frequency associated with the sensor being interrogated.
